(19) United States
(12) Patent Application Publication
(10) Pub. No.: US 2009/0034177 A1
(43) Pub. Date: Feb. 5, 2009

(54) Supporting Assembly for a Liquid Crystal Display

(75) Inventors: Therm-Hoo Ke, Hsin-Chu (TW); Ying-Feng Hsu, Hsin-Chu (TW); Chi-Chun Yang, Hsin-Chu (TW); Tzu-Yi Liu, Hsin-Chu (TW); Li-Chuan Yu, Hsin-Chu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORPORATION, Hsin-Chu (TW)

(21) Appl. No.: 12/052,285

(22) Filed: Mar. 20, 2008

(30) Foreign Application Priority Data
Aug. 1, 2007 (TW) 96128281

(51) Int. Cl. G06F 1/16

(52) U.S. Cl. 361/681

(57) ABSTRACT

A supporting assembly for a LCD includes a front bezel, a cover, a first fastener, a back bezel, a second fastener, a frame, a lighting carrier. The cover is extended from the front bezel. The first fastener is disposed on the cover. The back bezel is coupled to the front bezel and has an opening opposite the cover. The second fastener is disposed on the back bezel and fastened to the first fastener. The frame is disposed between the front bezel and the back bezel and has a carrier socket opposite the cover. The lighting carrier is plugged into the carrier socket.

### RELATED APPLICATIONS

This application claims priority to Taiwan Patent Application Serial Number 96128281, filed Aug. 1, 2007, which is herein incorporated by reference.

### BACKGROUND

1. Field of Invention

The present invention relates to a liquid crystal display. More particularly, the present invention relates to a liquid crystal display having a replaceable light source.

2. Description of Related Art

The liquid crystal display (LCD) is a display device which utilizes liquid crystal to display images. Comparing to the conventional cathode ray tube (CRT), the LCD has more flexibility in size and weight. Therefore, the LCD has been applied to various kinds of personal systems, e.g. mobile phones, personal digital assistants (PDAs), digital cameras, televisions or billboards.

An obvious difference between the LCD and the CRT is that the CRT can radiate light by itself, but the liquid crystal of the LCD cannot; that is to say, the CRT can display images without any additional light source, but the LCD needs a backlight module to display images.

The LCD may display images with insufficient or ununiform backlight when the backlight module of the LCD has at least one broken light source. In order to repair the LCD, a maintenance worker has to take the backlight module apart from the LCD to replace the broken light source with a new one. However, the repair process mentioned above is complex for the maintenance worker and may damage other elements of the LCD when taking the backlight module apart.

### SUMMARY

According to one embodiment of the present invention, a supporting assembly for a LCD includes a front bezel, a cover, a first fastener, a back bezel, a second fastener, a frame, a lighting carrier. The cover is extended from the front bezel. The first fastener is disposed on the cover. The back bezel is coupled to the front bezel and has an opening opposite the cover. The second fastener is disposed on the back bezel and fastened to the first fastener. The frame is disposed between the front bezel and the back bezel and has a carrier socket opposite the cover. The lighting carrier is plugged into the carrier socket.

According to another embodiment of the present invention, a LCD includes a front bezel, a cover, a first fastener, a back bezel, a second fastener, a frame, a liquid crystal panel, a lighting carrier and a lighting element. The cover is extended from the front bezel. The first fastener is disposed on the cover. The back bezel is coupled to the front bezel and has an opening opposite the cover. The second fastener is disposed on the back bezel and fastened to the first fastener. The frame is disposed between the front bezel and the back bezel and has a carrier socket opposite the cover. The liquid crystal panel is held by the frame. The lighting carrier is plugged into the carrier socket. The lighting element is installed in the lighting carrier.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a three dimensional view of a LCD according to one embodiment of the present invention;

FIG. 2 is an exploded view of the LCD of FIG. 1;

FIG. 3 shows how to take the lighting carrier apart from the LCD of FIG. 1;

FIG. 4 is an enlarged view taken on the corner A of FIG. 1, wherein the front bezel has been taken apart; and

FIG. 5 is an exploded view of another LCD according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

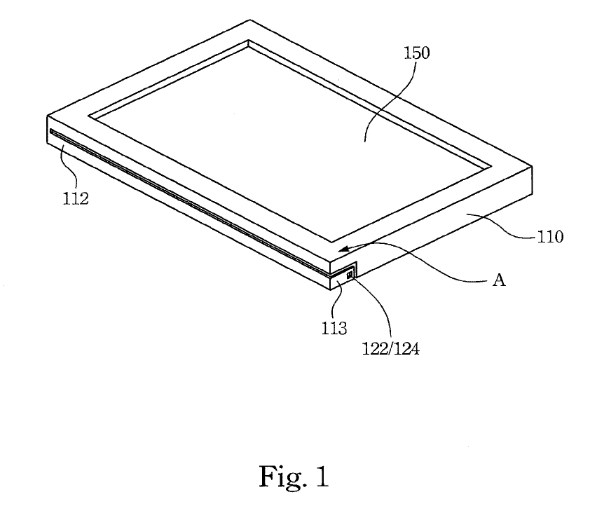

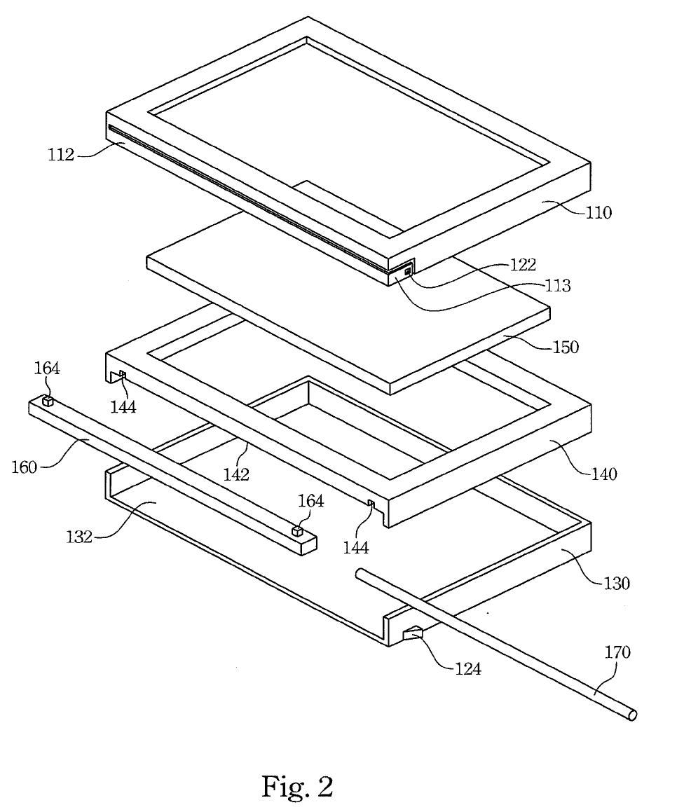

FIG. 1 is a three dimensional view of a LCD according to one embodiment of the present invention. FIG. 2 is an exploded view of the LCD of FIG. 1. The LCD includes a front bezel 110, a cover 112, a first fastener 122, a back bezel 130, a second fastener 124, a frame 140, a liquid crystal panel 150, a lighting carrier 160 and a lighting element 170. The cover 112 is extended from the front bezel 110. The first fastener 122 is disposed on the cover 112. The back bezel 130 is coupled to the front bezel 110 and has an opening 132 opposite the cover 112. The second fastener 124 is disposed on the edge of the back bezel 130 and fastened to the first fastener 122. The frame 140 is disposed between the front bezel 110 and the back bezel 130 and has a carrier socket 142 opposite the cover 112. The liquid crystal panel 150 is held by the frame 140. The lighting carrier 160 is plugged into the carrier socket 142. The lighting element 170 is installed in the lighting carrier 160.

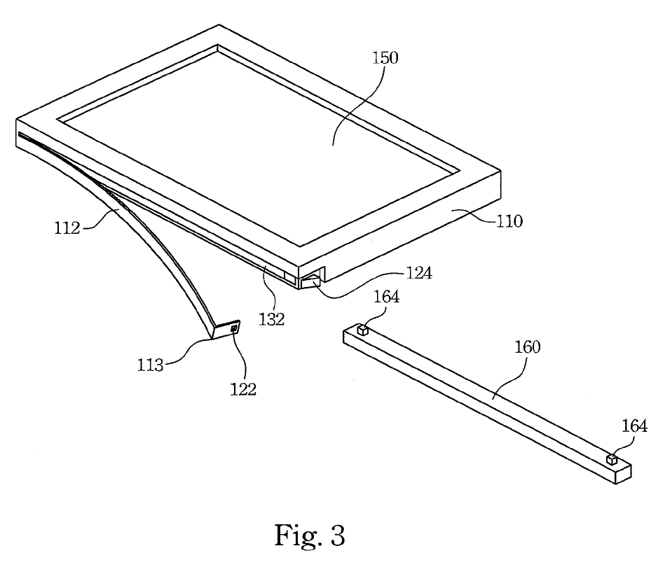

FIG. 3 shows how to take the lighting carrier apart from the LCD of FIG. 1. In maintenance, a maintenance worker may unfasten the first fastener 122 and the second fastener 124 to lift the cover 112 first. Then, the maintenance worker can take the lighting carrier 160 apart from the LCD to replace the lighting element, installed in the lighting carrier 160. Alternatively, the maintenance worker may replace both the lighting carrier 160 and the lighting element as well.

In the prefer embodiment, the first fastener 122 is a female fastener, and the second fastener 124 is a male fastener. The first fastener and the second fastener can also be another proper fastener (for example, a pin, a screw or Velcro). People skilled in the art can select a proper fastener as the first fastener and the second fastener if necessary.

The cover 112, shown in FIG. 1, may be made of an elastic material or a flexible material. For example, the cover 112 may be made of metal, such as steel, aluminium or copper. Accordingly, the maintenance worker may bend the connection between the front bezel 110 and the cover 112 (without any hinge) to lift the cover 112. Furthermore, the cover 112 may have a turn 113 with an L-shaped section to completely cover the opening 132, shown in FIG. 2, and the carrier socket 142, shown in FIG. 2.

The frame 140, shown in FIG. 2, may have at least one positioning hole 144 located in the carrier socket 142. The positioning hole 144 may be exposed through a surface of the frame 140 which is opposite the cover 112. The lighting carrier 160 may have at least one positioning pin 164. In use, the positioning pin 164 can be inserted into the positioning hole 144 to fix the location of the lighting carrier 160 in the carrier socket 142.

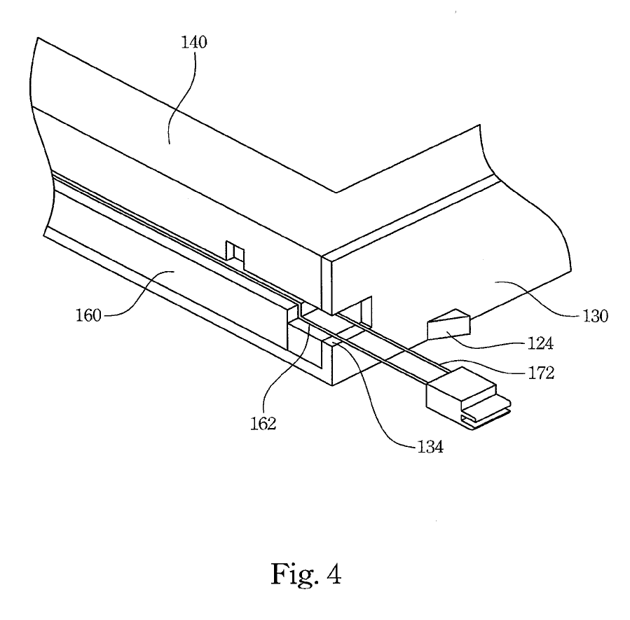

FIG. 4 is an enlarged view taken on the corner A of FIG. 1, wherein the front bezel 110 has been taken apart. The lighting carrier 160 may have a first outlet 162 located on one end thereof. The back bezel 130 may have a second outlet 134 aligned with the first outlet 162. Therefore, the electrical circuit 172 of the lighting element 170 can extend through the first outlet 162 and the second outlet 134 to pass through the gap between the front bezel 110 and the back bezel 130. Alternatively, the electrical circuit 172 of the lighting element 170 may be stored between the front bezel 110 and the back bezel 130 as well.

The lighting element 170, shown in FIG. 2, may be, but not limited to, a cold cathode fluorescent lamp (CCFL) or a light emitting diode (LED). It is easily understood that the lighting element 170 is only one of the examples. The lighting element 170 can also be another proper lighting source. People skilled in the art can select a proper lighting source as the lighting element if necessary.

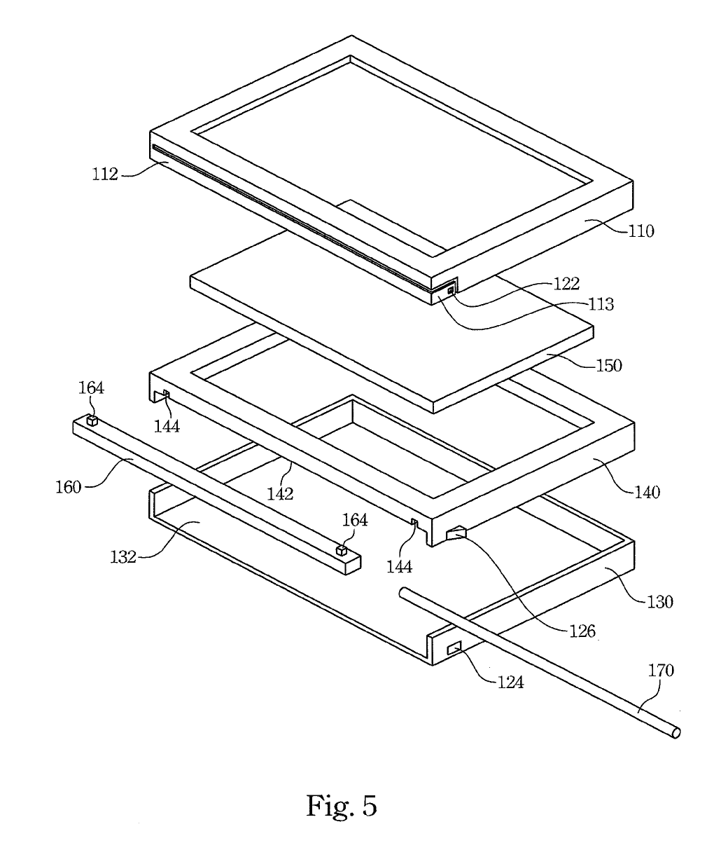

FIG. 5 is an exploded view of another LCD according to another embodiment of the present invention. In the present embodiment, the LCD may further include a third fastener 126 disposed on the frame 140. In use, the first fastener 122, the second fastener 124 and the third fastener 126 may be fastened together to couple the front bezel 110 and the back bezel 130. Furthermore, the first fastener 122, the second fastener 124 and the third fastener 126 can also close the cover 112 to prevent the lighting carrier 160 from dropping off.

More specifically, both the first fastener 122 and the second fastener 124 may be female fasteners, and the third fastener 126 may be a male fastener. In use, the third fastener 126 (male fastener) may be inserted into the first fastener 122 and the second fastener 124 (female fasteners) to fix the cover 112.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A supporting assembly for a liquid crystal display, the supporting assembly comprising:
a front bezel;
a cover extended from the front bezel;
a first fastener disposed on the cover;
a back bezel coupled to the front bezel and having an opening opposite the cover;
a second fastener disposed on the back bezel and fastened to the first fastener;
a frame disposed between the front bezel and the back bezel and having a carrier socket opposite the cover; and
a lighting carrier plugged into the carrier socket.

2. The supporting assembly of claim 1, wherein the first fastener is a female fastener, and the second fastener is a male fastener.

3. The supporting assembly of claim 1, wherein the cover is made of an elastic material or a flexible material.

4. The supporting assembly of claim 1, wherein the cover is made of metal.

5. The supporting assembly of claim 1, wherein the lighting carrier has a first outlet located on one end thereof.

6. The supporting assembly of claim 5, wherein the back bezel has a second outlet aligned with the first outlet.

7. The supporting assembly of claim 1, wherein the frame has at least one positioning hole located in the carrier socket.

8. The supporting assembly of claim 7, wherein the positioning hole is exposed through a surface of the frame which is opposite the cover.

9. The supporting assembly of claim 7, wherein the lighting carrier has at least one positioning pin inserted into the positioning hole.

10. The supporting assembly of claim 1, wherein the cover has a turn with an L-shaped section.

11. The supporting assembly of claim 1, further comprising:
a third fastener disposed on the frame, wherein the first fastener, the second fastener and the third fastener are fastened together.

12. The supporting assembly of claim 11, wherein both the first fastener and the second fastener are female fasteners, and the third fastener is a male fastener.

13. A liquid crystal display comprising:
a front bezel;
a cover extended from the front bezel;
a first fastener disposed on the cover;
a back bezel coupled to the front bezel and having an opening opposite the cover;
a second fastener disposed on the back bezel and fastened to the first fastener;
a frame disposed between the front bezel and the back bezel and having a carrier socket opposite the cover;
a liquid crystal panel held by the frame;
a lighting carrier plugged into the carrier socket; and
a lighting element installed in the lighting carrier.

14. The liquid crystal display of claim 13, wherein the first fastener is a female fastener, and the second fastener is a male fastener.

15. The liquid crystal display of claim 13, wherein the cover is made of an elastic material or a flexible material.

16. The liquid crystal display of claim 13, wherein the cover is made of metal.

17. The liquid crystal display of claim 13, wherein the lighting carrier has a first outlet located on one end thereof.

18. The liquid crystal display of claim 17, wherein the back bezel has a second outlet aligned with the first outlet.

19. The liquid crystal display of claim 13, wherein the frame has at least one positioning hole located in the carrier socket.

20. The liquid crystal display of claim 19, wherein the positioning hole is exposed through a surface of the frame which is opposite the cover.

21. The liquid crystal display of claim 19, wherein the lighting carrier has at least one positioning pin inserted into the positioning hole.

22. The liquid crystal display of claim 13, wherein the cover has a turn with an L-shaped section.

23. The liquid crystal display of claim 13, wherein the lighting element is a cold cathode fluorescent lamp.

24. The liquid crystal display of claim 13, wherein the lighting element is a light emitting diode.

25. The liquid crystal display of claim 13, further comprising:
a third fastener disposed on the frame, wherein the first fastener, the second fastener and the third fastener are fastened together.

26. The liquid crystal display of claim 25, wherein both the first fastener and the second fastener are female fasteners, and the third fastener is a male fastener.
